(19) United States
(12) Patent Application Publication
(10) Pub. No.: US 2021/0399360 A1
(43) Pub. Date: Dec. 23, 2021

(54) COMPOSITE MATERIAL AND METHOD OF PRODUCTION

(71) Applicant: SCHUNK CARBON TECHNOLOGY GMBH, Bad Goisem (AT)

(72) Inventor: Florian Huber, Bad Ischl (AT)

(21) Appl. No.: 17/349,408

(22) Filed: Jun. 16, 2021

(30) Foreign Application Priority Data
Jun. 17, 2020 (DE) 10 2020 115 999.4

(51) Int. Cl. H01M 10/655; H01M 10/658

(52) U.S. Cl. CPC H01M 10/655; H01M 2220/20; H01M 10/658

(57) ABSTRACT

The invention relates to a composite material for forming a latent heat store, an accumulator comprising the composite material, a method for producing the composite material, and its use, the composite material being made of a porous matrix material and a filling material, the filling material being inserted in pores of the matrix material, the filling material being a phase change material, the phase change material having a melting temperature in a range of 15° C. to 200° C., wherein the matrix material contains graphite with intercalated acid.

This application claims the benefit of German Patent Application No. 10 2020 115 999.4 filed on Jun. 17, 2020, the disclosure of which is incorporated herein by reference.

### TECHNICAL FIELD

The invention relates to a composite material for forming a latent heat store, an accumulator comprising the composite material, a method for producing the composite material, and its use, the composite material being made of a porous matrix material and a filling material, the filling material being inserted in pores of the matrix material, the filling material being a phase change material, the phase change material having a melting temperature in a range of 15° C. to 200° C.

### SUMMARY

Latent heat stores are sufficiently known and can often also be made of composite materials. A latent heat store uses the enthalpy of a thermodynamic change in state of the filling material serving as the storage medium. When a transition from the solid phase to the liquid phase or vice-versa occurs, thermal energy is stored or released. For example, melting the filling material, i.e., the phase change material, requires a large amount of thermal energy, which can be released to an environment upon re-solidification. Salt solutions or paraffins, to which what is known as a nucleating agent may be added in order to effect crystallization close to the melting temperature, can be used as the phase change material. Depending on the phase change material used, the melting temperature can be in a range of 15° C. to 200° C. This means that a phase transition from solid to liquid can take place in this temperature range under normal conditions, i.e., at a pressure of 100 kPa.

A latent heat store configured in this manner can serve as a heat sink in connection with a technical installation, for example, in order to prevent overheating and a resulting failure of the technical installation. In order to suitably connect the filling material, i.e., the phase change material, to the technical installation and to ensure proper heat transfer, it is known for the phase change material to be inserted into a porous matrix material. The phase change material, i.e., the filling material, then fills at least partially, preferably fully, porous matrix material. A use of porous matrix materials is also known inter alia from construction technology, for example by inserting phase change material into porous insulation materials as the matrix material. These known composite materials, which are used as latent heat stores, are disadvantageous in that the composite material cannot be used for temperatures significantly higher than the melting temperature of the phase change material when it is used as a heat sink for a technical installation.

### FIELD OF THE INVENTION

Hence, the object of the present invention is to propose a composite material, a method for its production, and a use of the composite material which allow extended utilization.

This object is attained by a composite material having the features of claim 1, an accumulator having the features of claim 13, a vehicle having the features of claim 14, a method having the features of claim 15, and a use having the features of claim 18.

The composite material according to the invention for forming a latent heat stores or the like is made of a porous matrix material and a filling material, the filling material being inserted in pores of the matrix material, the filling material being a phase change material, the phase change material having a melting temperature in a range of 15° C. to 200° C., wherein the matrix material contains graphite with intercalated acid.

According to the invention, the matrix material contains or consists of non-expanded graphite intercalate, i.e., what is known as graphite salt. The matrix material can at least partially or entirely consist of graphite intercalate. In particular, acid compounds or salts are stored between graphite layers, said acid compounds or salts evaporating when a certain temperature is reached and causing the graphite to expand by driving the graphite layers apart. In this case, the composite material is configured in such a manner that the matrix material has not yet expanded in this way. In principle, graphite is not very suitable for discharging thermal energy and does not have a porosity great enough for it to be reasonably usable for inserting a phase change material; however, graphite is still used as a matrix material herein since the described advantageous properties of the graphite with intercalated acid can be exploited. The composite material can initially serve as a heat sink when the composite material is in contact with a heating component of a technical installation. When the phase change material changes from solid to liquid, a large amount of thermal energy can be dissipated from the component. If a heating or a temperature of the component in question has progressed or increased to a point where dissipation of thermal energy via the phase change material is no longer possible and there is the risk, for example, that the component might catch fire or set adjacent components aflame, the graphite with the intercalated acid can expand. This expansion causes an intumescent layer to form on the component, said intumescent layer forming a flame-resistant layer, cutting off access of atmospheric oxygen to the component and counteracting a production of gases and smoke. So the composite material is not only advantageously usable as a latent heat store but can also prevent fire or at least limit the extent thereof in the event of an unexpected temperature increase.

### DESCRIPTION OF THE INVENTION

The phase change material can have a melting temperature in a range of 50° C. to 150° C. The phase change materials can be adapted to a temperature within said range by suitable selection or composition of the phase change material. Therefore, the composite material is easily adaptable to various fields of application.

The composite material can have a mass fraction of graphite with intercalated acid which is selected such that the graphite with intercalated acid can expand starting at a temperature of 200° C. In addition to the mass fraction of acid, a particle size of the graphite can also be varied since the particle size of the graphite can also be used to adjust a starting temperature for an expansion. A starting temperature of 200° C. allows an expansion of the graphite with intercalated acid, i.e., the graphite intercalate, to start in time well before dangerous ignition temperatures are reached. Alternatively, the mass fraction of acid can be selected such that the graphite with intercalated acid expands starting at a temperature in a range of 151° C. to 230° C.

The composite material can contain a mass fraction of 0.5 to 10% by mass of graphite with intercalated acid, the inserted acid preferably being nitric acid or sulfuric acid. An expansion rate of the intercalated graphite can be influenced in the desired manner by varying the mass fraction of acid in the composite material. The nitric acid or the sulfuric acid can be concentrated nitric acid or concentrated sulfuric acid intercalated in the graphite. The inserted acid can be homogeneously distributed in the non-expanded graphite, i.e., the graphite intercalate.

The graphite with intercalated acid can exhibit an expansion rate of 50 cm³/g to 150 cm³/g. Alternatively, the graphite with intercalated acid can exhibit an expansion rate of 30 cm³/g to 400 cm³/g. Accordingly, the graphite intercalate can multiply its volume upon expansion, the filling material within the expanded graphite intercalate being preserved. Hence, when the graphite intercalate expands, the filling material is also effectively surrounded by the expanded graphite intercalate and is not released into an environment.

A resin, a polymer and/or short cut fibers can be added to the matrix material as an additive. The additive can be homogenously distributed in the matrix material. By adding the additive, a desired strength of the matrix material—and therefore essentially of the composite material—can be obtained. If the matrix material consists essentially of graphite powder, it can be solidified by means of a resin, for example, in such a manner that the composite material is provided with a structurally stable shape. Furthermore, reinforcing fibers may be added to the matrix material, which do not significantly change the expansion of the matrix material but do have an advantageous effect on strength. Short cut fibers of this kind can be carbon fibers, for example. The matrix material can consist of expanded graphite and graphite with intercalated acid. Advantageously, the matrix material consists essentially entirely of graphite. The expanded graphite can be expandable graphite in whose pores the graphite with intercalated acid can be inserted together with the filling material. Alternatively, the expandable graphite can also be used as a porous additive which is admixed to the graphite with intercalated acid together with the filling material and solidified. The expanded graphite or the expandable graphite can be easily produced by induced expansion of graphite with intercalated acid. Expandable graphite has a relatively high porosity, which is suitable for inserting filling material. The graphite can be natural graphite or synthetic graphite.

The matrix material can be configured to exhibit anisotropic expansion behavior. For example, an anisotropic expansion behavior can be obtained by adding fibers or short cut fibers which largely have the same spatial orientation to the matrix material. When the graphite intercalate expands, it does so essentially in the direction of a fiber orientation. This anisotropic expansion behavior can be advantageously adapted to a shape of a component connected to the composite material.

The phase change material can alternatively consist of an organic substance, preferably of long-chain, branched or unbranched hydrocarbons or long-chain hydrocarbon acids or polymerized hydrocarbon modules, particularly preferably paraffin.

The phase change material can consist of an inorganic substance, preferably of a salt hydrate on the basis of lithium, sodium, potassium, magnesium, calcium, aluminum or ammonium as a cation and a nitrate, sulfate, carbonate, acetate, chloride, bromide, thiosulfate, dihydrogen phosphate, hydrogen phosphate or phosphate as an anion; particularly preferably, nucleating additives can be added to the salt hydrate. The addition of nucleating additives allows a thermally reversible melting and solidification process of the salt hydrates to be achieved.

In another embodiment, the phase change material can consist of a metallic substance, preferably of gallium or a eutectic alloy with gallium, indium or tin.

Furthermore, the filling material can also be a mixture of at least two phase change materials, wherein the phase change materials can have different melting temperatures. The composite material can be adapted to a recurring heat curve on a component and serve as a heat sink for two different temperatures or within different temperature ranges. Nevertheless, a broad temperature range can also be effectively covered in this way.

The accumulator according to the invention is provided with an envelope made of a composite material according to the invention. The accumulator can be an accumulator on the basis of alkali metals, such as lithium, sodium, potassium, or alkaline earth metals, such as magnesium or calcium. In these types of accumulators, said metals can react with atmospheric oxygen, humidity or water, which can lead to spontaneous combustion of the accumulator and during which hydrogen gas may be released. Such an accumulator often heats up substantially during charging or discharging. The thermal energy produced in the process can be dissipated advantageously via the phase change material of the composite material. If the temperature of the accumulator or of an accumulator cell heats excessively, for example as a result of an overload, a short-circuit or damage, the accumulator or the accumulator cell could be destroyed, in which case electrode material of the accumulator could be released and ignite. In this case, when a critical temperature is exceeded, the composite material enveloping the accumulator or the accumulator cell will expand in such a manner that the accumulator will be covered at least partially in an affected area or entirely by the expanding graphite intercalate, which forms an intumescent layer on a surface of the accumulator or the accumulator cell. Thus, the electrode material cannot come into contact with atmospheric oxygen, humidity or water, which means that an ignition of the accumulator is effectively prevented before a fire even occurs or spreading of a fire is inhibited. Nevertheless, the composite material also protects fully functional accumulators against damage from fire acting on the accumulator from the outside.

The vehicle according to the invention, which has an electric drive, has an accumulator according to the invention. Other advantageous properties of the vehicle are apparent from the description of features of the dependent claims referencing device claim 1. Since accumulators of vehicles also tend to catch fire as a result of accidents, a use of the accumulator according to the invention in an electric vehicle is particularly advantageous.

In the method according to the invention for producing a composite material, in particular latent heat stores or the like, the composite material is made of a porous matrix material and a filling material, the filling material being inserted into pores of the matrix material, a phase change material being used as the filling material, the phase change material having a melting temperature in a range of 15° C. to 200° C., the matrix material being made of graphite with intercalated acid. Regarding the advantages of the method according to the invention, reference is made to the description of advantages of the device according to the invention.

In an embodiment of the method, the matrix material can be made of a homogeneous powder mixture made of the graphite with intercalated acid and a porous additive, wherein the powder mixture can be solidified into a porous green body in a mold, wherein the green body can be infiltrated with the filling material in the liquid phase and a body can be made of the composite material. Accordingly, a structurally stable green body can first be formed in a mold by compressing the homogenous powder mixture, for example. The graphite intercalate, which can be present in the form of a powder, can be compressed with the porous additive in such a manner that the green body has a sufficient amount or proportion of pores relative to a volume of the green body, into which the filling material can be inserted. The porous additive can be expandable graphite, for example. Another additive, such as another resin or another suitable material, can be added to the powder mixture so that the powder mixture can be easily solidified by curing the resin in the mold without tight compression of the powder mixture being required. The pores of the green body can essentially be filled by liquefying the filling material, i.e., the phase change material, through heating and infiltrating the green body with the phase change material. Infiltration can take place by means of a vacuum, for example. The thus obtained body made of the composite material can have a shape which is adapted to the shape of a component of a technical installation from which thermal energy is to be dissipated and which is to be protected against fire.

According to another embodiment of the method, the matrix material can be made of a homogeneous powder mixture of the graphite with intercalated acid, a porous additive and the filling material in the solid phase, wherein the powder mixture can be solidified into a body made of the composite material in a mold. Unlike in the variation of the method described before, the filling material, i.e., the phase change material, is also in the form of a powder and is homogeneously mixed with the graphite intercalate and the porous additive. The porous additive can be expandable graphite, for example. By compressing and/or solidifying said powder mixture, the body can be made of the composite material.

Since the filling material does not have to be liquefied, a component can also be coated with the composite material in principle. The composite material can be easily solidified into the body by means of another additive, such as a resin which is cured.

Other advantageous embodiments of the method are apparent from the description of features of the dependent claims referencing device claim 1.

When the composite material made of a porous matrix material and a filling material is used according to the invention, the filling material being inserted in pores of the matrix material, the filling material being a phase change material, the phase change material having a melting temperature in a range of 15° C. to 200° C., the matrix material containing graphite with intercalated acid, the composite material is used to envelop an accumulator. Regarding the advantageous effects of the use of the composite material, reference is made to the description of advantages of the composite material according to the invention.

The composite material can be used as a heat sink for the accumulator, wherein a temperature of the accumulator can be increased until a melting temperature of the filling material is exceeded and the filling material changes from the solid phase into the liquid phase.

The composite material can also be used as a fire-resistant cladding for the accumulator, wherein a temperature of the accumulator or a temperature of an immediate environment of the accumulator can be increased until the graphite with intercalated acid expands and an intumescent layer can be formed on the accumulator.

Other advantageous embodiments of a use are apparent from the description of features of the dependent claims referencing device claim 1.

1. A composite material for forming a latent heat store or the like, the composite material being made of a porous matrix material and a filling material, the filling material being inserted in pores of the matrix material, the filling material being a phase change material, the phase change material having a melting temperature in a range of 15° C. to 200° C.,
characterized in that
the matrix material contains graphite with intercalated acid.

2. The composite material according to claim 1,
characterized in that
the phase change material has a melting temperature in a range of 50° C. to 150° C.

3. The composite material according to claim 1,
characterized in that
the composite material contains a mass fraction of graphite with intercalated acid which is selected such that the graphite with intercalated acid expands starting at a temperature of 200° C.

4. The composite material according to claim 1,
characterized in that
the composite material contains a mass fraction of 0.5 to 10 percent by mass of graphite with intercalated acid, the inserted acid preferably being nitric acid or sulfuric acid.

5. The composite material according to claim 1,
characterized in that the graphite with intercalated acid has an expansion rate of 50 cm³/g to 150 cm³/g.

6. The composite material according to claim 1,
characterized in that
a resin, a polymer and/or short cut fibers are added as an additive to the matrix material.

7. The composite material according to claim 1,
characterized in that
the matrix material consists of expanded graphite and graphite with intercalated acid.

8. The composite material according to claim 1,
characterized in that
the matrix material is configured to exhibit anisotropic expansion behavior.

9. The composite material according to claim 1,
characterized in that
the phase change material consists of an organic substance, preferably of long-chain, branched or unbranched hydrocarbons or long-chain hydrocarbon acids or polymerized hydrocarbon modules, particularly preferably of paraffin.

10. The composite material according to claim 1,
characterized in that
the phase change material consists of an inorganic substance, preferably of a salt hydrate on the basis of lithium, sodium, potassium, magnesium, calcium, aluminum or ammonium as a cation and a nitrate, sulfate, carbonate, acetate, chloride, bromide, thiosulfate, di-hydrogen phosphate, hydrogen phosphate or phosphate as an anion, nucleating additives being particularly preferably added to the salt hydrate.

11. The composite material according to claim 1,
characterized in that
the phase change material consists of a metallic substance, preferably of gallium or a eutectic alloy with gallium, indium or tin.

12. The composite material according to claim 1,
characterized in that
the filling material is a mixture of at least two phase change materials, the phase change materials having different melting temperatures.

13. An accumulator comprising an envelope made of a composite material according to claim 1.

14. A vehicle having an electric drive and an accumulator according to claim 13.

15. A method for producing a composite material, in particular a latent heat store or the like, the composite material being made of a porous matrix material and a filling material, the filling material being inserted into pores of the matrix material, a phase change material being used as the filling material, the phase change material having a melting temperature in a range of 15° C. to 200° C., the matrix material being made of graphite with intercalated acid.

16. The method according to claim 15,
characterized in that
the matrix material is made of a homogenous powder mixture of the graphite with intercalated acid and a porous additive, the powder mixture being solidified into a green body in a mold, the green body being infiltrated with the filling material in the liquid phase and a body being made of the composite material.

17. The method according to claim 15,
characterized in that
the matrix material is made of a homogenous powder mixture of the graphite with intercalated acid, a porous additive and the filling material in the solid phase, the powder mixture being solidified into a body made of the composite material in a mold.

18. A use of a composite material made of a porous matrix material and a filling material, the filling material being inserted in pores of the matrix material, the filling material being a phase change material, the phase change material having a melting temperature in a range of 15° C. to 200° C., the matrix material containing graphite with intercalated acid, for enveloping an accumulator.

19. The use according to claim 18,
characterized in that
the composite material is used as a heat sink for the accumulator, a temperature of the accumulator being increased until a melting temperature of the filling material is exceeded and the filling material changes from the solid phase into the liquid phase.

20. The use according to claim 18,
characterized in that
the composite material is used as a fire-resistant cladding for the accumulator, a temperature of the accumulator or a temperature of an immediate environment of the accumulator being increased until the graphite with intercalated acid expands and an intumescent layer is formed on the accumulator.
